(19) United States
(12) Patent Application Publication
(10) Pub. No.: US 2025/0171644 A1
(43) Pub. Date: May 29, 2025

(54) INFRARED PERMEABLE BRILLIANT COATING FILM AND INFRARED PERMEATION COVER

(71) Applicant: TOYODA GOSEI CO., LTD., Kiyosu-shi, Aichi-ken (JP)

(72) Inventors: Koichi MIYAKE, Kiyosu-shi, Aichi-ken (JP); Koji KUNO, Kiyosu-shi, Aichi-ken (JP); Hiroaki ANDO, Kiyosu-shi, Aichi-ken (JP); Seiichi SUZUKI, Saitama-shi (JP)

(21) Appl. No.: 18/841,955

(22) PCT Filed: Mar. 17, 2023
(86) PCT No.: PCT/JP2023/010773

§ 371 Date: Aug. 27, 2024

(30) Foreign Application Priority Data
Mar. 28, 2022 (JP) 2022-051144

(51) Int. Cl. C09D 5/03; C09D 7/40; C09D 7/62

(52) U.S. Cl. CPC C09D 5/032; C09D 7/62; C09D 7/69

(57) ABSTRACT

An infrared-transmissive sparkle coating film includes an infrared-transmissive base plastic and filler particles added to the base plastic. The filler particles each include an aluminum flake and infrared-transmissive plastic films covering opposite surfaces of the flake in a thickness direction. A thickness of each plastic film is greater than a thickness of the flake. A diameter of the filler particle is in a range of 10 μm to 120 μm. A weight concentration of the filler particles is in a range of 0.1% to 1.0%. An area occupancy of the filler particles is in a range of 0.5% to 1.5%.

### TECHNICAL FIELD

The present disclosure relates to an infrared-transmissive sparkle coating film and an infrared-transmissive cover.

### BACKGROUND ART

Patent Literature 1 discloses an infrared-transmissive product. The infrared-transmissive product includes, for example, a body that covers, from the front, an infrared sensor arranged rearward from the front grille of a vehicle. The body includes a transparent base and a coating film layer formed on the rear surface of the transparent base. The transparent base and the coating film layer are both infrared-transmissive. The transparent base is made of a plastic material such as polycarbonate. The coating film layer includes a transparent plastic such as an epoxy plastic and aggregates dispersed in the transparent plastic. The aggregates are formed by aggregated fine particles of multiple types of pigment. The pigment may include titanium oxide or the like scattering light on the surfaces of the particles to exhibit a white color.

Such an infrared-transmissive product has infrared transmissivity and visible-light reflectivity.

Further, some exterior members of vehicles typically include a metallic coating film containing a transparent base plastic and filler particles added to the base plastic. Such exterior components can create a sparkling metallic appearance when visible light is reflected on aluminum flakes forming the filler particles.

### CITATION LIST

### Patent Literature

Patent Literature 1: Japanese Laid-Open Patent Publication No. 2021-56346

### SUMMARY OF INVENTION

### Technical Problem

It is desired that an infrared-transmissive sparkle coating film and an infrared-transmissive cover create a metallic appearance while having high infrared transmissivity.

### Solution to Problem

An infrared-transmissive sparkle coating film that solves the above problem includes an infrared-transmissive base plastic and filler particles added to the base plastic. The filler particles each include an aluminum flake and infrared-transmissive plastic films covering opposite surfaces of the flake in a thickness direction. The thickness of each plastic film is greater than a thickness of the flake. The diameter of the filler particle is in a range of 10 μm to 120 μm. The weight concentration of the filler particles is in a range of 0.1% to 1.0%. The area occupancy of the filler particles is in a range of 0.5% to 1.5%.

In order to cause a coating film to create a metallic appearance, aluminum flakes may be used alone as filler particles added to the base plastic. In this case, as the amount of the filler particles increases, the flakes are more likely to contact each other. Thus, gaps through which infrared rays pass are reduced, and the infrared rays are more likely to be reflected on the flakes. This will result in a decrease in infrared transmittance.

In contrast, as the amount of the filler particles decreases, the infrared transmittance increases. However, since visible light is less likely to be reflected on the flakes, a created metallic appearance is insufficient.

In this respect, the above structure, in which the thickness of the plastic film is greater than the thickness of the flake, avoids an excessive decrease in the distances between flakes in the base plastic. By setting the diameter of the filler particle, the weight concentration of the filler particles, and the area occupancy of the filler particles as in the above structure, the light transmittance of the sparkle coating film is in a range of 70% to 92% in both the first wavelength band in a range of 880 nm to 930 nm and the second wavelength band in a range of 1540 nm to 1560 nm. In addition, the graininess of the sparkle coating film, that is, a G value, is in a range of 5 to 30. As the graininess, i.e. the G value, increases, glare increases.

This creates a metallic appearance while having a high infrared transmissivity of the infrared radar device in the two wavelength bands.

In the infrared-transmissive sparkle coating film, preferably, the thickness of the filler particle is in a range of 1 μm to 3 μm, and the thickness of the flake is in a range of 20 nm to 100 nm.

This structure, in which an excessive decrease in the distances between the flakes in the base plastic is sufficiently avoided, increases the light transmittance of the infrared radar device in the two wavelength bands. The structure also sufficiently ensures the thickness of the flake to increase glare.

Preferably, the infrared-transmissive sparkle coating film has a thickness in a range of 5 μm to 50 μm.

When the thickness of the sparkle coating film is less than 5 μm, the graininess tends to be less than 5, and the glare is difficult to increase. In contrast, when the thickness of the sparkle coating film is greater than 50 μm, the light transmittance tends to be less than 70%.

In this respect, the above structure, in which the sparkle coating film has a thickness in the range of 5 μm to 50 μm, avoids the occurrence of the above problem. This further ensures the advantage of creating a metallic appearance while having a high light transmittance of the infrared radar device in the two wavelength bands.

An infrared-transmissive cover that solves the above problem includes an infrared-transmissive transparent base, the above infrared-transmissive sparkle coating film arranged on the transparent base, and a visible-light blocking layer arranged on a surface of the sparkle coating film at a side opposite to the transparent base, the visible-light blocking layer preventing transmission of visible light.

This structure provides the same operational advantages as the above infrared-transmissive sparkle coating films.

### BRIEF DESCRIPTION OF DRAWINGS

FIG. 1 is a cross-sectional view of a cover according to one embodiment.

FIG. 2 is a cross-sectional view of a filler particle forming a sparkle coating film of FIG. 1.

FIG. 3 is an enlarged cross-sectional view of the sparkle coating film of FIG. 1.

### DESCRIPTION OF EMBODIMENTS

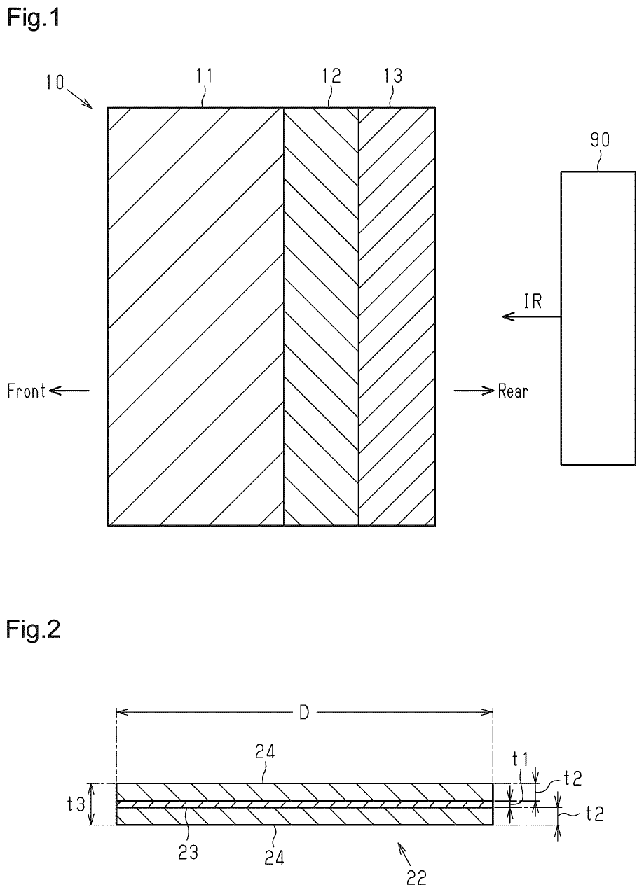

An infrared-transmissive cover and an infrared-transmissive sparkle coating film according to one embodiment will now be described with reference to FIGS. 1 to 3.

As shown in FIG. 1, a vehicle includes an infrared radar device 90. The infrared radar device 90 emits infrared rays IR having wavelengths in a first wavelength band in a range of 880 nm to 930 nm or a second wavelength band in a range of 1540 nm to 1560 nm.

In the following description, the ‘front’ and ‘rear’ in the direction in which the infrared rays from the infrared radar device 90 are emitted will simply be referred to as ‘front’ and ‘rear’, respectively.

As shown in FIG. 1, the vehicle includes an infrared-transmissive cover (hereinafter, cover 10) that covers the infrared radar device 90 from the front.

The cover 10 includes an infrared-transmissive transparent base 11, an infrared-transmissive sparkle coating film 12 arranged on the transparent base 11, and a visible-light blocking layer 13 arranged on the surface of the sparkle coating film 12 at the side opposite to the transparent base 11 and preventing transmission of visible light.

The transparent base 11 is made of a plastic material such as polycarbonate, polymethyl methacrylate, cycloolefin polymer, or plastic glass. The transparent base 11 of the present embodiment is made of polycarbonate.

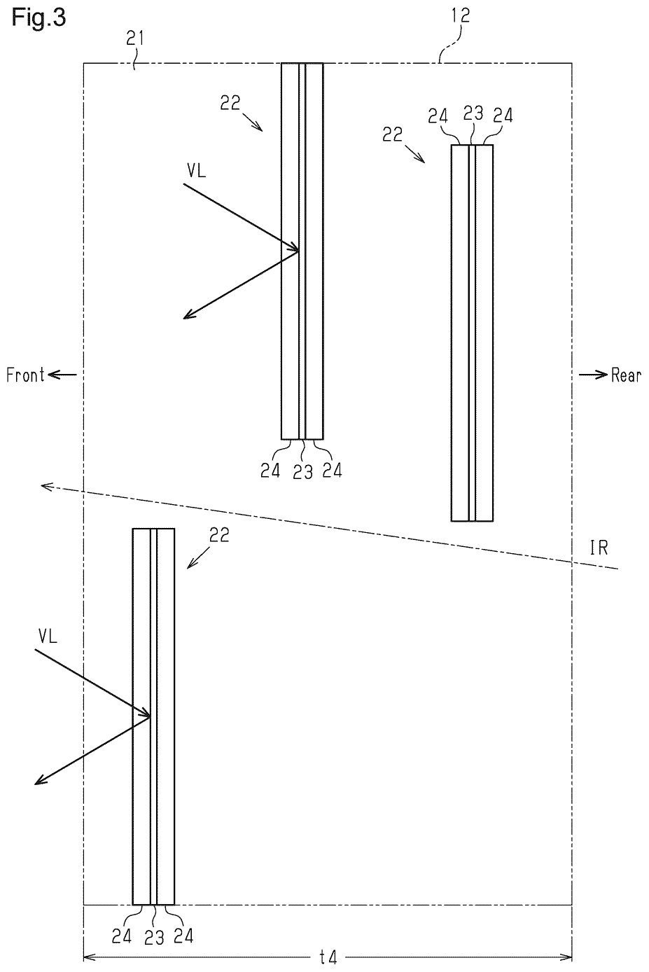

As shown in FIG. 3, the sparkle coating film 12 contains an infrared-transmissive base plastic 21 and filler particles 22 added to the base plastic 21.

The sparkle coating film 12 is formed by applying a coating containing the base plastic 21 and the filler particles 22 to the rear surface of the transparent base 11. The coating may contain a curing agent.

### Base Plastic 21

The base plastic 21 as used herein contains at least one of the following as a main component: epoxy resin, silicone resin, urethane, urea-formaldehyde resin, phenol resin, polyethylene, polypropylene, polyethylene terephthalate, vinyl chloride, polystyrene, acrylonitrile-butadiene-styrene copolymer, acrylic resin, polyamide, polyimide, polycarbonate, or melamine resin. The main component refers to a component that affects the properties of the material, and the content of the main component is greater than or equal to 50% by mass of the entire material.

The curing agent is used depending on the material of the base plastic 21. If the base plastic 21 used herein contains epoxy resin as the main component, an acid anhydride curing agent or a phenol curing agent may be used. If the base plastic 21 used herein contains material other than epoxy plastic as the main component, a curing agent may be omitted.

Depending on the purpose and the intended use, a curing agent other than an acid anhydride curing agent or a phenol curing agent may be used. Examples of such curing agents include an amine-based curing agent, an agent obtained by partially esterificating an acid anhydride curing agent with alcohol, and a curing agent of carboxylic acid such as hexahydrophthalic acid, tetrahydrophthalic acid, and methyl-hexahydrophthalic acid. One of the listed curing agents may be used alone. Alternatively, two or more of the curing agents may be used in combination. Further, any of the curing agents may be used with an acid anhydride curing agent and a phenol curing agent.

In a case in which a curing agent is used, a curing accelerator may be used together with the curing agent.

### Filler Particles 22

As shown in FIG. 2, each filler particle 22 includes an aluminum flake 23 and infrared-transmissive plastic films 24 covering the opposite surfaces of the flake 23 in the thickness direction. Each plastic film 24 is made of, for example, an acrylic-based, urethane-based, ester-based, or siloxane-based resin. The filler particle 22 may be colored by adding pigment to the plastic film 24.

The filler particle 22 has a flat shape. The plastic film 24 has a thickness t2 that is greater than a thickness t1 of the flake 23 (t2>t1).

The filler particle 22 has a diameter D in a range of 10 μm to 120 μm. The diameter D of the filler particle 22 is the maximum length of the filler particle 22 in the planar direction.

The filler particle 22 has a thickness t3 preferably in a range of 1 μm to 3 μm.

The thickness t1 of the flake 23 is in a range of 20 nm to 100 nm.

In the present embodiment, the thickness t3 of the filler particle 22 is 2 μm (2000 nm). The thickness t1 of the flake 23 is 60 nm. The thickness t2 of the plastic film 24 is 970 nm. The thickness t3 of the filler particle 22, the thickness t1 of the flake 23, and the thickness t2 of the plastic film 24 satisfy the relationship of the following Equation 1.

t3=t1+t2×2 (Equation 1)

The filler particle 22 is formed, for example, as follows. First, a first plastic film is formed on a substrate. An aluminum film is formed on the first plastic film through vapor deposition. Then, a second plastic film is formed on the aluminum film. A sheet having a structure of three layers is formed in this manner. Then, the sheet is pulverized to form the filler particle 22. In this case, the plastic films 24 are arranged only on the opposite surfaces of the flake 23.

The weight concentration of the filler particles 22 in the sparkle coating film 12 is in a range of 0.1% to 1.0%.

The area occupancy of the filler particles 22 in the sparkle coating film 12 is in a range of 0.5% to 1.5%.

Preferably, the sparkle coating film 12 has a thickness t4 in a range of 5 μm to 50 μm. More preferably, the sparkle coating film 12 has a thickness t4 in a range of 20 μm to 40 μm. The thickness t4 of the sparkle coating film 12 of the present embodiment is 30 μm.

The visible-light blocking layer 13 is, for example, a known black-out coating film. A visible-light blocking pigment may be added to the black-out coating film.

Operation of the present embodiment will now be described.

As shown by the long-dash double-short-dash line in FIG. 3, in the sparkle coating film 12, the infrared rays IR emitted from the infrared radar device 90 pass through the gaps between the filler particles 22. In addition, visible light VL entering the sparkle coating film 12 through the transparent base 11 is reflected on the front surfaces of the flakes 23 of the filler particles 22. The cover 10 shows a black color exhibited by the visible-light blocking layer 13. In addition, the cover 10, in which the visible light VL is reflected on the flakes 23, creates a sparkling metallic appearance.

The present embodiment has the following advantages.

(1) Each filler particle 22 includes the aluminum flake 23 and the infrared-transmissive plastic films 24 covering the opposite surfaces of the flake 23 in the thickness direction. The thickness t2 of the plastic film 24 is greater than the thickness t1 of the flake 23. The diameter D of the filler particle 22 is in the range of 10 μm to 120 μm. The weight concentration of the filler particles 22 is in the range of 0.1% to 1.0%. The area occupancy of the filler particles 22 is in the range of 0.5% to 1.5%.

Such a structure, in which the thickness t2 of the plastic film 24 is greater than the thickness t1 of each flake 23, avoids an excessive decrease in the distances between the flakes 23 in the base plastic 21. By setting the diameter D of the filler particle 22, the weight concentration of the filler particles 22, and the area occupancy of the filler particles 22 as in the above structure, the light transmittance of the sparkle coating film 12 in both the first wavelength band and the second wavelength band is in a range of 70% to 92%. In addition, the graininess of the sparkle coating film 12, that is, a G value is in a range of 5 to 30. As the graininess, i.e. the G value, increases, glare increases. This creates a metallic appearance while having a high infrared transmissivity of the infrared radar device 90 in the two wavelength bands.

(2) The thickness t3 of the filler particle 22 is in the range of 1 μm to 3 μm. The thickness t1 of the flake 23 is in the range of 20 μm to 100 μm.

Such a structure, in which an excessive decrease in the distances between the flakes 23 in the base plastic 21 is sufficiently avoided, increases the light transmittance of the infrared radar device 90 in the two wavelength bands. The structure also sufficiently ensures the thickness t1 of the flake 23 to increase glare.

(3) The sparkle coating film 12 has the thickness t4 in the range of 5 μm to 50 μm.

When the thickness t4 of the sparkle coating film 12 is less than 5 μm, the graininess, i.e. the G value, tends to be less than 5 and the glare is unlikely to increase. In contrast, when the thickness t4 of the sparkle coating film 12 is greater than 50 μm, the light transmittance tends to be less than 70%.

In this respect, the above structure, in which the sparkle coating film 12 has the thickness t4 in the range of 5 μm to 50 μm, avoids the occurrence of the above problem. This further ensures the advantage of creating a metallic appearance while having a high infrared transmissivity of the infrared radar device 90 in the two wavelength bands.

(4) The cover 10 includes the infrared-transmissive transparent base 11, the sparkle coating film 12 arranged on the transparent base 11, and the visible-light blocking layer 13 arranged on the surface of the sparkle coating film 12 at the side opposite to the transparent base 11 and preventing transmission of visible light.

Such a structure provides the same operational advantages as the above operational advantages (1) to (3).

### Modifications

The present embodiment may be modified as described below. The present embodiment and the following modifications can be combined if the combined modifications remain technically consistent with each other.

The plastic film 24 may cover the peripheral edges of the flake 23 in addition to the opposite surfaces of the flake 23. In other words, the flake 23 of the filler particle 22 may be entirely covered by the plastic film 24.

The thickness t4 of the sparkle coating film 12 may be less than 5 μm or greater than 50 μm.

The thickness t3 of the filler particle 22 may be less than 1 μm or greater than 3 μ.

The thickness t1 of the flakes 23 may be less than 20 nm or greater than the 100 nm.

1. An infrared-transmissive sparkle coating film, comprising:
an infrared-transmissive base plastic; and
filler particles added to the base plastic, wherein
the filler particles each include an aluminum flake and infrared-transmissive plastic films covering opposite surfaces of the flake in a thickness direction,
a thickness of each plastic film is greater than a thickness of the flake,
a diameter of the filler particle is in a range of 10 μm to 120 μm,
a weight concentration of the filler particles is in a range of 0.1% to 1.0%, and
an area occupancy of the filler particles is in a range of 0.5% to 1.5%.

2. The infrared-transmissive sparkle coating film according to claim 1, wherein
a thickness of the filler particle is in a range of 1 μm to 3 μm, and
a thickness of the flake is in a range of 20 nm to 100 nm.

3. The infrared-transmissive sparkle coating film according claim 1, wherein the sparkle coating film has a thickness in a range of 5 μm to 50 μm.

4. An infrared-transmissive cover, comprising:
an infrared-transmissive transparent base;
the infrared-transmissive sparkle coating film according to claim 1, the sparkle coating film being arranged on the transparent base; and
a visible-light blocking layer arranged on a surface of the sparkle coating film at a side opposite to the transparent base, the visible-light blocking layer preventing transmission of visible light.
